(19) United States
(12) Patent Application Publication
(10) Pub. No.: US 2026/0213606 A1
(43) Pub. Date: Jul. 23, 2026

(54) ELECTRIC COMPRESSOR

(71) Applicant: Hanon Systems, Daejeon (KR)

(72) Inventors: Hyun Woo Lee, Daejeon (KR); Seung Yong Hwang, Daejeon (KR); Min Gyu Kim, Daejeon (KR); Seung Kil Kim, Daejeon (KR); Sang Woo Bae, Daejeon (KR); Hew Nam Ahn, Daejeon (KR); Sung Taeg Oh, Daejeon (KR); Young Seop Yoon, Daejeon (KR); Je Su Yun, Daejeon (KR); Hye Rim An

(21) Appl. No.: 19/139,442

(22) PCT Filed: Nov. 6, 2023
(86) PCT No.: PCT/KR2023/017646

§ 371 Date: Jun. 16, 2025

(30) Foreign Application Priority Data
Dec. 20, 2022 (KR) 10-2022-0179703

(51) Int. Cl. H02K 5/22; H02K 7/14

(52) U.S. Cl. CPC H02K 5/225; H02K 7/14; H02K 2203/09

(57) ABSTRACT

An electric compressor with a housing, a motor part provided in the housing, a compression part driven by the motor part, an inverter part coupled to one side of the housing and configured to control an operation of the motor part, and a terminal unit configured to electrically connect the motor part and the inverter part to each other, wherein the terminal unit includes a terminal part, and a terminal holder allowing the terminal part to be coupled thereto, and wherein the electric compressor has improved coupling reliability when the terminal part is inserted thereinto as a protrusion height of the terminal is reduced.

### CROSS REFERENCE TO RELATED APPLICATION

The present application claims priority to Korea Patent Application No. 10-7 2022-0179703, filed on Dec. 20, 2022, the entire contents of which are incorporated herein for all purposes by this reference.

### TECHNICAL FIELD

The present disclosure relates to an electric compressor, more particularly, to an electric compressor capable of improving an insulation performance by changing a structure of a terminal part.

### BACKGROUND ART

In general, an air-conditioning system for cooling or heating a passenger compartment is provided in a vehicle. Such an air-conditioning system includes a compressor configured to compress a gaseous refrigerant at a low temperature and a low pressure introduced from an evaporator into a gaseous refrigerant at a high temperature and a high pressure to be provided to a condenser.

The compressor applied in the vehicle may be classified into a mechanical compressor configured to be driven by a driving force received from an engine and an electric compressor configured to use a motor driven by electric power, and recently, use of the electric compressor is increasing as the electrification of the vehicle is accelerated.

Meanwhile, as an example of the compressor, there are a reciprocating compressor that compresses a refrigerant according to which pistons reciprocate, and a rotary compressor that compresses a refrigerant while rotating. The reciprocating compressor includes a crank compressor that transmits a driving force from a drive source to a plurality of pistons using a crank, a swash plate compressor that transmits a driving force from a drive source to a rotary shaft installed with a swash plate, and the like, according to the power transmission method from the drive source. The rotary compressor includes a vane rotary compressor that utilizes a rotating rotary shaft and vane, and a scroll compressor that utilizes an orbiting scroll and a fixed scroll.

In addition, development of a compressor of an inverter type capable of varying the operating speed of the motor has been actively conducted. In the electric compressor in the inverter type, an inverter is mounted on an outer circumferential surface or a side surface of a casing, and the inverter is electrically connected to the motor provided in the casing using a bus bar and a terminal penetrating the casing.

An inverter unit provided in the conventional electric compressor will be described.

The conventional inverter-integrated electric compressor includes a driving part (not illustrated) and a compression part (not illustrated) provided inside a main housing (not illustrated), and an inverter unit disposed inside the inverter housing on one surface of the main housing.

A bus bar is provided in the inverter casing, and a terminal unit including a terminal pin is provided in the driving part, thereby an electric connection between the driving part and the inverter unit is formed. That is, the terminal unit is electrically connected to the inverter unit through the bus bar.

Such a conventional inverter-integrated electric compressor had problems in that an unnecessary dead volume of the inverter unit increased due to the bus bar, and a quantity and a weight of parts increased because both the bus bar and the terminal unit were used, leading to increased complexity in an assembly process.

In addition, the conventional inverter-integrated electric compressor had a problem in that a volume for the overall packaging increased because a gap distance for insulation had to increase inevitably under a condition of a high voltage because a terminal pin provided in the terminal unit is formed in a cylindrical shape.

It is difficult to manufacture the terminal pin in a cylindrical shape, sealing thereof is difficult, and when using the bus bar, the bus bar is disposed to protrude toward the driving part from the inverter unit, and thus, the bus bar causes a problem in height reduction. Accordingly, a measure to solve such problems is needed.

### DISCLOSURE

### Technical Problem

Embodiments of the present disclosure aims to provide an electric compressor having improved electric insulation between a printed circuit board and a terminal by changing a structure of a terminal part.

### Technical Solution

One embodiment is an electric compressor, including: a housing; a motor part provided in the housing; a compression part driven by the motor part; an inverter part coupled to one side of the housing and configured to control an operation of the motor part; and a terminal unit configured to electrically connect the motor part and the inverter part to each other, and the terminal unit may include: a plurality of terminal parts; and a terminal holder allowing the terminal parts to be coupled thereto at a certain interval, and surfaces of the plurality of terminal parts facing each other may be flat surfaces.

A cross-section of the terminal part may be quadrangular.

The terminal part may be a sheet having a certain thickness and extending in a longitudinal direction.

The electric compressor may include: one or more terminals configured to electrically contact the terminal part so as to allow an extending end of the terminal part to be coupled thereto and to be electrically connected to a printed circuit board.

A plurality of terminal pins may be formed in the terminal.

The terminal pins may be disposed in parallel with each other in a width direction of the terminal part.

The terminal pins may be formed at positions parallel to a longitudinal direction of the terminal part.

The terminal pins may be directly fixed to a printed circuit board.

In the terminal holder, an extension extending to protrude more than a surface on which the terminal holder may be formed in a longitudinal direction of the terminal part.

The extension may cover an outer surface of the terminal part with an insulation material in a certain area.

The terminal parts may be formed of a metal or a non-ferrous metal made of different materials.

The terminal part may have an insulation layer formed on an outer surface thereof for electric insulation.

The insulation layer may be one selected among a silver plate or a tin plate.

The terminal holder may allow the terminal part to be inserted thereinto, and have an insulation member covering an outside.

The insulation member may be molded by double molding together with the terminal holder.

### Advantageous Effect

Embodiments of the present disclosure may have a gap distance which is increased more than a gap distance under a condition of the same voltage, and may be used in a high voltage vehicle by changing a configuration of a terminal part, thereby limitation due to the installation can be reduced.

Embodiments of the present disclosure have advantages in that sealing performance of the terminal part is improved and thus, sealing area is increased compared to a conventional terminal part formed in a cylindrical shape, and manufacture thereof is easy.

Embodiments of the present disclosure allow electric connection between the motor part and the inverter part to be maintained stably when installed in the electric compressor.

Embodiments of the present disclosure allow a connection structure between the terminal part and the printed circuit board to be improved simply, thereby workability and assembling efficiency of the operator is improved, and weight and expenses incurred by the manufacture is reduced.

Embodiments of the present disclosure may secure an insulation distance between terminal pins on the printed circuit board connected to each of a plurality of terminal parts, like that in which a plurality of terminal parts are spaced apart from each other for insulation.

### DESCRIPTION OF DRAWINGS

FIG. 1 is a vertical cross-sectional view of an electric compressor according to an embodiment of the present disclosure.

FIG. 2 is a perspective view illustrating a state in which a terminal holder according to the present embodiment is installed in a printed circuit board.

FIG. 3 is a vertical cross-sectional view of a terminal part according to the present embodiment.

FIGS. 4 to 5 are views illustrating a terminal holder of a terminal unit according to the present embodiment.

FIG. 6 is a view illustrating a state in which a terminal unit according to the present embodiment is installed in a printed circuit board and is coupled to a terminal part.

### MODE FOR INVENTION

Advantages and characteristics of the present disclosure and a method of achieving the advantages and characteristics will be clear by referring to exemplary embodiments described below in detail together with the accompanying drawings.

However, the present disclosure is not limited to exemplary embodiment disclosed herein but will be implemented in various forms. The exemplary embodiments are provided by way of example only so that a person of ordinary skilled in the art can fully understand the disclosures of the present disclosure and the scope of the present disclosure. Therefore, the present disclosure will be defined only by the scope of the appended claims. Like reference numerals refer to like elements throughout.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. As used herein, the term “and/or” includes, but is not limited to any and all combinations of one or more of the associated listed items.

The terms used in the present specification are for describing example embodiments and are not intended to limit the inventive concept. In the present specification, a singular form also includes a plural form unless particularly stated in the phrase. Components, steps, operations and/or elements that are referred to by terms “comprises” and/or “comprising” used in the inventive concept do not exclude presence or addition of one or more other components, steps, operations and/or elements.

Although the terms “first”, “second”, and the like are used for describing various components, these components are not confined by these terms. These terms are merely used for distinguishing one component from the other components.

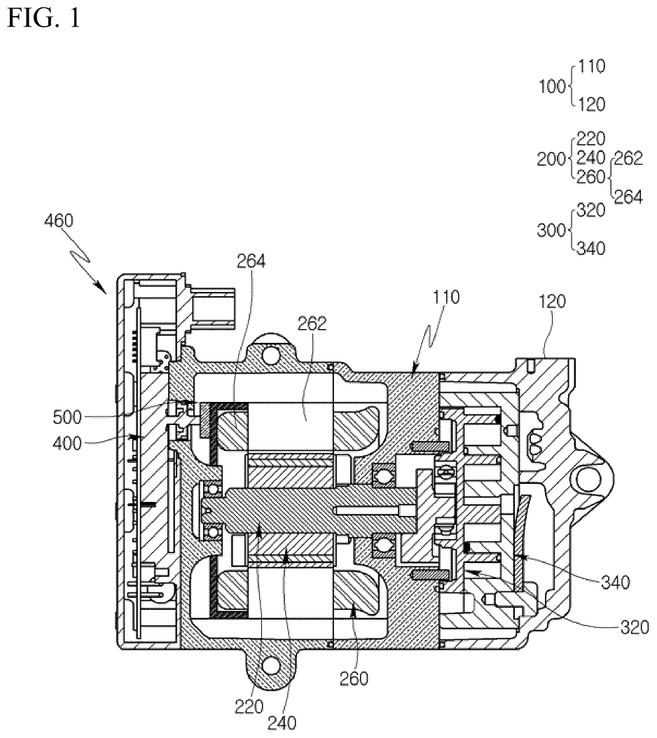

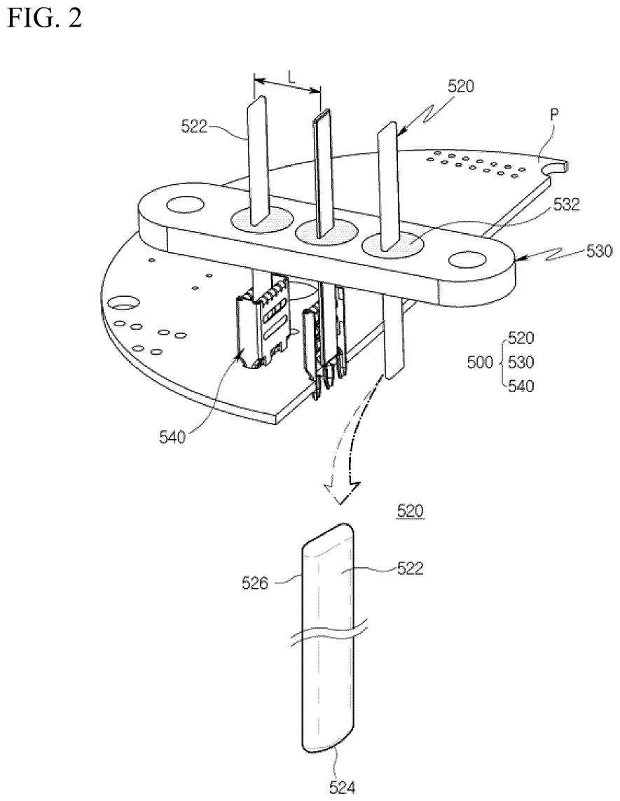

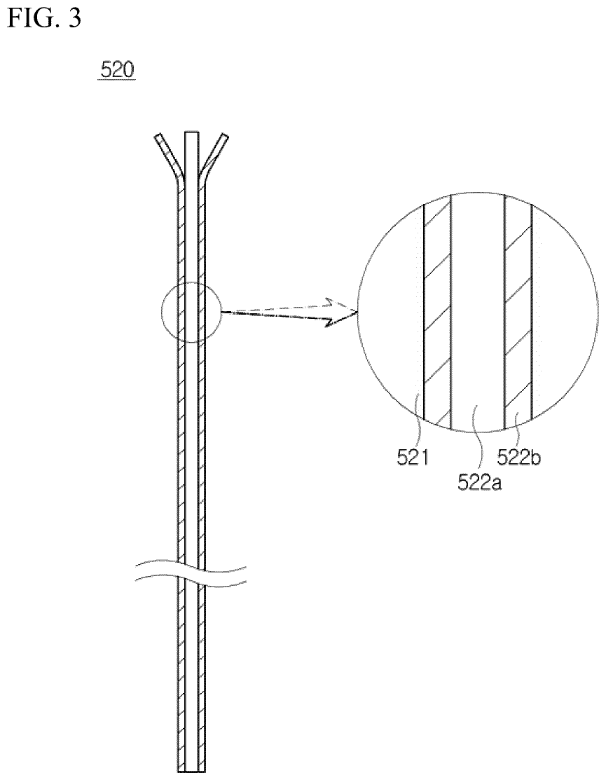

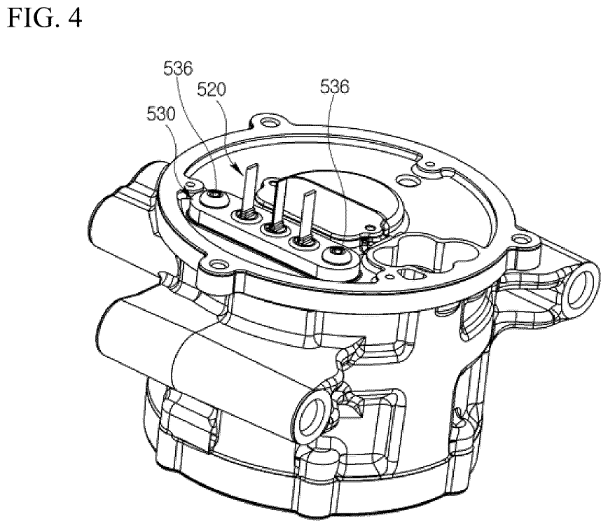

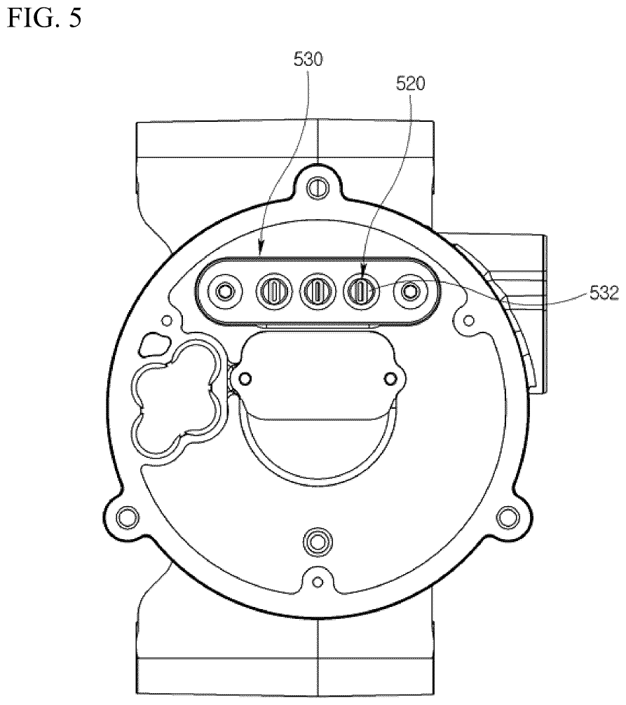

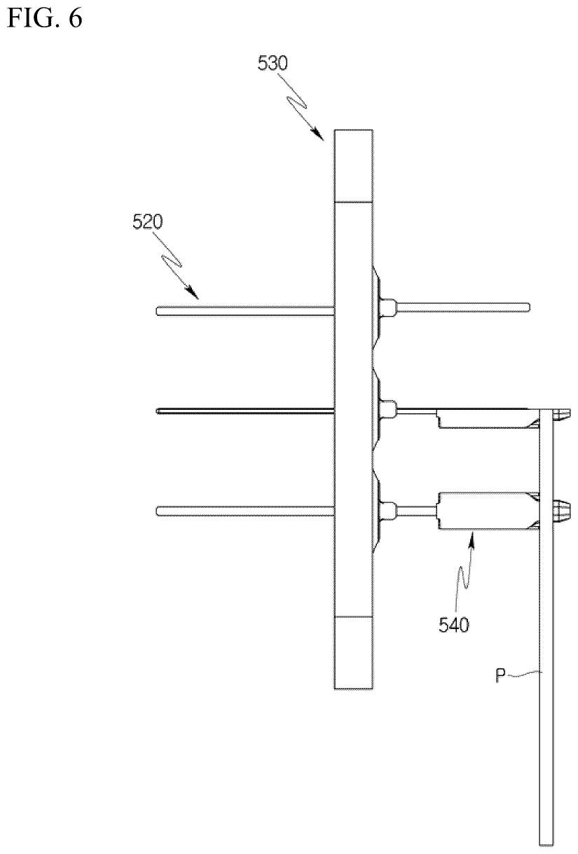

Hereinafter, a configuration of an electric compressor according to an embodiment of the present disclosure will be described in further detail with reference to the accompanying drawings. FIG. 1 is a vertical cross-sectional view of an electric compressor according to an embodiment of the present disclosure; FIG. 2 is a perspective view illustrating a state in which a terminal holder according to the present embodiment is installed in a printed circuit board; FIG. 3 is a vertical cross-sectional view of a terminal part according to the present embodiment; FIGS. 4 to 5 are views illustrating a terminal holder of a terminal unit according to the present embodiment; and FIG. 6 is a view illustrating a state in which a terminal unit according to the present embodiment is installed in a printed circuit board and a state in which a terminal unit according to the present embodiment is coupled to a terminal part.

Referring to FIGS. 1 to 6, the electric compressor according to the present 21 embodiment includes a housing 100, a motor part 200, a compression part 300, an inverter 22 part 400, and a terminal unit 500 configured to electrically connect the motor part 200 and the inverter part 400 to each other.

The housing 100 defines the overall external appearance of the electric compressor, and in the present embodiment, the housing 100 is formed of a front housing 110 and a rear housing 120.

The motor part 200 is provided in the front housing 110, and provides power for the compression part 300 to compress the refrigerant. The motor part 200 includes a rotor 240 coupled to a rotational axis 220 rotatably installed at a center of the front housing 110, and a stator 260 fixed to the front housing 110 and disposed on a radial outside of the rotor 240. The stator 260 includes a stator core 262, and a coil 264 wound on the stator core 262.

The compression part 300 is provided in the rear housing 120, and includes an orbiting scroll 320 coupled to the rotational axis 220 through an eccentric bush, and a fixed scroll 340 fixed between the front housing 110 and the rear housing 120 and forming a compression chamber in which compression of the refrigerant is performed together with the orbiting scroll 320.

As such, a rotational force generated in the motor part 200 may be provided to the orbiting scroll 320 of the compression part through the rotational axis 220 as the compression part 300 is connected to the motor part 200 through the rotational axis 220.

The inverter part 400 is provided on an outside of the housing 100, and coupled to a side opposite to the compression part 300 on the basis of the motor part 200. The inverter part 400 is electrically connected to the motor part 200, and applies power to the motor part 200 and controls operations through power provided from the outside and control signals.

More particularly, the stator 260 forms an electromagnetic field by power applied from the inverter part 400, and a rotational force for operating the compression part 300 is generated as the rotor 240 rotates by the electromagnetic field formed by the stator 260.

In the inverter part 400, a printed circuit board P on which switching elements are provided is provided, and an inverter case 460 coupled to the housing 100 and configured to accommodate the printed circuit board P is included.

A structure of the terminal unit 500 configured to electrically connect the motor part 200 and the inverter part 400 to each other will be described in more detail.

The terminal unit 500 according to the embodiment may include a terminal part 520, a terminal holder 530, and a terminal 540.

In the embodiment, a three-phase motor is used, therefore, three terminal parts 520 and three terminals 540, each of which is connected to the three phases, are provided in order to supply the three-phase power to the motor part 200 from the inverter part 400.

The three terminal parts 520 are connected to the three-phase coils 264 of the stator 260 of the motor part, respectively, penetrate the housing 100 inside the housing 100 and protrude inward of the inverter part 400.

The terminal part 520 according to the embodiment is not formed in a pin shape having a certain diameter like the prior art, and surfaces thereof facing each other are flat. In addition, the terminal part 520 is formed of a sheet having a certain thickness, protruding in a longitudinal direction, and having a quadrangular cross-section.

The reason the terminal part 520 has a sheet shape and a quadrangular cross-section is that an electrical insulation performance and a sealing performance can be improved at the same time and a stable coupling to the terminal 540 can be achieved, and a stable use under a condition of a high voltage can be facilitated by increasing a gap distance between the plurality of terminal parts 520 when the terminal parts 520 are installed in the terminal holder 530.

In this case, the embodiment may use the terminal unit 500 in a high voltage vehicle or a high-voltage electric compressor, therefore, withstand voltage characteristics can be dramatically improved.

As illustrated in FIG. 2, terminal bodies 522, of the terminal part 520, having a rectangular plate shape and having certain length and thickness, are coupled to a plurality of terminal holders 530, respectively, and terminals 540 are provided in a quantity corresponding to a quantity of the terminal part 520.

The terminal part 520 includes a first round portion 524 which is an end extending toward the terminal 540 from the terminal body 522 and has a streamlined shape, and a second round portion 526 which are longitudinal both ends having a streamlined shape.

In the terminal part 520, the first round portion 524 is formed at a lower end of the terminal body 522 to make sure stable insertion into an inside of the terminal 540 without getting caught, therefore, insertion thereof into the terminal 540 may be performed stably and constantly.

When the terminal part 520 is formed as above, contact stability according to coupling to the terminal 540 is improved, thereby the electrical connection can be maintained constantly.

The second round portion 526 is formed to be rounded at a certain radius of curvature so as not to be bent at a right angle in a longitudinal direction of the terminal part 520, concentration of the electrical energy is prevented, leading to make stable use possible.

In particular, when the terminal parts 520 are coupled to the terminal holder 530, because a gap distance L between the terminal parts 520 is maintained as illustrated in drawings, the gap distance increases compared to a case of the same voltage, thereby stable use is possible under a condition of a high voltage.

The terminal body 522 includes a first terminal body portion 522a defining an overall external appearance and formed of a first material, and a second terminal body portion 522b formed of a different material from the first terminal body portion 522a and formed on an outer surface of the first terminal body portion 522a.

The terminal part 520 may be configured as a double-material part formed of the first terminal body portion 522a and the second terminal body portion 522b so as to maintain a stable electric insulation performance.

For example, the first terminal body portion 522a and the second terminal body portion 522b may be formed of each different material. For example, the first terminal body portion 522a may be formed of stainless steel, and the second terminal body portion 522b may be formed of an inorganic material. However, the above-described materials are merely examples for convenience of description, and may be changed to different materials.

The first terminal body portion 522a is formed of stainless steel and forms the overall structure, and the second terminal body portion 522 b is bonded to an outer surface of the first terminal body portion 522a to form the terminal part 520.

As described above, when the terminal part 520 is formed of differential materials, the electric insulation performance can be stabilized compared to a case in which the terminal part 520 is formed of a single material. In addition, when such a terminal part 520 formed of different materials are used in the terminal unit 500 which makes the electric insulation performance constant, more stable operation can be achieved.

Furthermore, when the terminal part 520 is installed and used in the electric compressor in which the terminal unit 500 is installed, a stable voltage may be maintained, thereby operational stability is improved.

The second terminal body portion 522b is formed of an inorganic material, and a plurality of terminal parts 520 are spaced apart from each other, therefore, electric interference between each other is minimized, thereby a stable insulation performance is maintained.

Accordingly, the electric compressor in which the terminal unit 500 is installed may be stably operated at a constant voltage, and even when the electric compressor is used under a high voltage condition, it can be used without instabilized electric insulation performance.

In the terminal unit 500 according to the embodiment, an insulation layer 521 for electric insulation is formed on an outer surface of the terminal body 522.

In this case, the terminal part 520 may be manufactured such that the terminal body 522 is manufactured first and a plating process for forming the insulation layer 521 on an outer surface is conducted.

The insulation layer 521 maintains the electric insulation to be constant due to a gap distance between terminal parts 520, thereby stable operation can be secured under a condition to which a certain voltage or a high voltage is applied.

Into the terminal holder 530, the terminal part 520 is inserted, and an insulation member 532 covering from the outside is provided in the terminal holder 530. The insulation member 532 may be formed of plastic resin or rubber, but may be formed of other material.

The insulation member 532 may be molded by double molding together with the terminal holder 530, therefore, the insulation performance may be provided on an outside of the terminal holder 530.

The terminal part 520 may maintain a gap distance between each other when the terminal part 520 is installed in the terminal 540 and maintain the stable insulation performance through the insulation layer 521, thereby stable operation of the electric compressor can be maintained.

As illustrated in the drawing, the terminal part 520 is inserted into an inside of the terminal 540 in a longitudinal direction when the terminal part 520 is inserted into the terminal 540, and maintains a state of being fully inserted into the terminal 540 rather than a partial insertion. In such a case, a contact stability between the terminal part 520 and the terminal 540 is improved, thereby the electric connection can be maintained constantly.

The terminal part 520 is coupled to the terminal holder 530 and is installed in the housing 100. When each of the terminal parts 520 is coupled to the terminal 540 installed on the printed circuit board P, the terminal parts 520 are electrically connected to the printed circuit board P.

The terminal 540 has a terminal pin 542 electrically connected to the printed circuit board P, and the terminal pin 542 is fixed to the printed circuit board P through direct soldering or other fixing methods.

A plurality of terminal pins 542 are formed in the terminal 540 and the terminal pins 542 are disposed in parallel with one another in a width direction of the terminal part 520.

In addition, the terminal pins 542 are formed at positions parallel to a longitudinal direction of the terminal part 520, and are directly fixed to the printed circuit board P.

As described above, when assembling constituent components coupled to the terminal part 520 into the housing 100 together with the motor part 200, the motor part 200, the terminal pin 542, and the terminal holder 530 are assembled in correct positions and the terminal pin 542 is inserted into a through hole formed in the printed circuit board P, thereby coupling to each other can be conducted easily through a soldering process thereafter.

In the terminal holder 530, fastening holes 532 are formed in ends on the left and the right on the basis of the drawing, and the fastening members 536 are inserted into the fastening holes 532, allowing the terminal holder 530 to be fastened to the housing 100.

When the terminal part 520 is inserted into the terminal holder 530 according to the embodiment, in order to facilitate reliable insulation and fixing, an extension 538 extending to protrude more than a surface on which the terminal holder 530 is formed is formed in a longitudinal direction of the terminal part 520.

Reliable insulation and fixing can be achieved at the same time because the extension 538 covers an outer surface of the terminal part 520 in a certain area, with an insulation material.

In addition, in the embodiment, when the terminal holder 530 is assembled, in a state in which the terminal 540 is soldered to the printed circuit board P, the terminal part 520, the terminal holder 530, and the extension 538 coupled to one another are coupled to the housing 100, and at the same time, one end of the terminal part 520 may be inserted into the terminal 540. With this configuration, the motor and the printed circuit board P can be electrically connected, and coupling of the motor and the printed circuit board P to the housing 100 can be carried out.

Although preferred embodiments of the present invention have been disclosed for illustrative purposes, those skilled in the art will appreciate that diverse variations and modifications are possible through addition, alteration, deletion, etc. of elements, without departing from the spirit and scope of the invention.

### INDUSTRIAL APPLICABILITY

The embodiments of the present disclosure may maintain stable electric connection of the motor part and the inverter part provided in the electric compressor.

1-15. (canceled)

16. An electric compressor comprising:
a housing;
a motor part provided in the housing;
a compression part driven by the motor part;
an inverter part coupled to one side of the housing and configured to control an operation of the motor part; and
a terminal unit configured to electrically connect the motor part and the inverter part to each other,
wherein the terminal unit further comprises:
a plurality of terminal parts; and
a terminal holder allowing each of the plurality of terminal parts to be coupled thereto at a certain interval, and wherein surfaces of the plurality of terminal parts facing each other are flat surfaces.

17. The electric compressor of claim 16, wherein a cross-section of each of the plurality of terminal parts is quadrangular.

18. The electric compressor of claim 16, wherein each of the plurality of terminal parts is a sheet having a certain thickness and extending in a longitudinal direction.

19. The electric compressor of claim 18 further comprising:
one or more terminals configured to electrically contact each of the plurality of terminal parts so as to allow an extending end of each of the plurality of terminal parts to be coupled thereto and to be electrically connected to a printed circuit board.

20. The electric compressor of claim 19, wherein a plurality of terminal pins is formed in the one or more terminals.

21. The electric compressor of claim 20, wherein the plurality of terminal pins is disposed in parallel with each other in a width direction of each of the plurality of terminal parts.

22. The electric compressor of claim 20, wherein the plurality of terminal pins is formed at positions parallel to a longitudinal direction of each of the plurality of terminal parts.

23. The electric compressor of claim 20, wherein the plurality of terminal pins is directly fixed to a printed circuit board.

24. The electric compressor of claim 20, wherein in the terminal holder, an extension extending to protrude more than a surface on which the terminal holder is formed in a longitudinal direction of each of the plurality of terminal parts.

25. The electric compressor of claim 24, wherein the extension covers an outer surface of each of the plurality of terminal parts with an insulation material in a certain area.

26. The electric compressor of claim 25, wherein each of the plurality of terminal parts is formed of a metal or a non-ferrous metal made of different materials.

27. The electric compressor of claim 26, wherein each of the plurality of terminal parts has an insulation layer formed on the outer surface thereof for electric insulation.

28. The electric compressor of claim 27, wherein the insulation layer is one selected among a silver plate or a tin plate.

29. The electric compressor of claim 16, wherein the terminal holder allows each of the plurality of terminal parts to be inserted thereinto, and has an insulation member covering an outside.

30. The electric compressor of claim 29, wherein the insulation member is molded by double molding together with the terminal holder.
